(19) United States
(12) Patent Application Publication
(10) Pub. No.: US 2018/0356684 A1
(43) Pub. Date: Dec. 13, 2018

(54) DISPLAY APPARATUS

(71) Applicant: Innolux Corporation, Miao-Li County (TW)

(72) Inventors: Heng-Chang CHANG, Miao-Li County (TW); Chin-Lung TING, Miao-Li County (TW)

(21) Appl. No.: 15/997,877

(22) Filed: Jun. 5, 2018

(30) Foreign Application Priority Data
Jun. 9, 2017 (CN) 201710431869.5

(51) Int. Cl. G02F 1/1335; F21V 8/00

(52) U.S. Cl. CPC G02F 1/133603; G02F 1/133605; G02B 6/0031; G02B 6/0025; G02B 6/0073

(57) ABSTRACT

A display apparatus comprises a display panel and a backlight module disposed below the display panel. The backlight module at least includes an optical film set and a light source assembly disposed below the optical film set, wherein the light source assembly comprises a glass substrate, plural light-emitting elements disposed on the glass substrate, and plural driving elements electrically connected to the light-emitting elements.

This application claims the benefit of People's Republic of China application Serial No. 201710431869.5, filed Jun. 9, 2017, the subject matters of which are incorporated herein by references.

### BACKGROUND

### Technical Field

The disclosure relates in general to a display apparatus, and more particularly to a display apparatus including a light source assembly having a glass substrate.

### Description of the Related Art

Electronic products with display panel, such as smart phones, tablets, notebooks, monitors, and TVs, have become indispensable necessities to modern people no matter in their work, study or entertainment. With a flourishing development of the portable electronic products, the consumers not only pursue better electronic characteristics such as higher display quality, higher speed of response, longer life span or higher reliability, but also have higher expects on the functions of the products to be more diversified. Moreover, it is an important matter for the manufacturer to simplify the process flow by improving the product design, or to reduce the environmental pollution which is generated from the manufacturing processes. Additionally, it is also important to meet the electrical performance requirements of the product (such as the specifications of resistances, capacities, etc.), thereby producing a display apparatus with great reliability of electrical characteristics.

### SUMMARY

According to one embodiment of the present disclosure, a display apparatus is provided, the display apparatus comprising a display panel and a backlight module, the backlight module disposed below the display panel. The backlight module at least comprises an optical film set and a light source assembly disposed below the optical film set, wherein the light source assembly comprises a glass substrate, a plurality of light-emitting elements disposed on the glass substrate, and a plurality of driving elements electrically connected to the plurality of light-emitting elements.

The disclosure will become apparent from the following detailed description of the preferred but non-limiting embodiments. The following description is made with reference to the accompanying drawings.

### BRIEF DESCRIPTION OF THE DRAWINGS

FIG. 1 is a cross-sectional view of a display apparatus according to one embodiment of the disclosure.

FIG. 2 is a simple drawing illustrating the first type of a light source assembly of a display apparatus according to one embodiment of the disclosure.

FIG. 3A is a simple drawing illustrating a glass substrate of the first type of a light source assembly according to a display apparatus of one embodiment of the disclosure.

FIG. 3B illustrates the light-emitting elements disposed on the glass substrate of the first type of a light source assembly according to a display apparatus of one embodiment of the disclosure.

FIG. 4 illustrates the second type of a light source assembly according to a display apparatus of one embodiment of the disclosure.

FIG. 5A is a simple drawing illustrating a glass substrate of the third type of a light source assembly according to a display apparatus of one embodiment of the disclosure.

FIG. 5B illustrates related components disposed on a glass substrate of the third type of a light source assembly according to a display apparatus of one embodiment of the disclosure.

FIG. 6A illustrates a display apparatus having a direct-illumination type backlight in one application of the disclosure.

FIG. 6B illustrates a display apparatus having a side-illumination type backlight in another application of the disclosure.

FIG. 7A illustrates another backlight module according to a display apparatus of one embodiment of the disclosure.

FIG. 7B is a top view of the reflective plate in FIG. 7A (viewed from the reflective surface of the reflective plate).

### DETAILED DESCRIPTION

In the embodiments of the present disclosure, a display apparatus is provided, a display apparatus comprises a light source assembly having a glass substrate, wherein several light-emitting elements of the light source assembly are disposed on the glass substrate. Compared to the light-emitting elements disposed on a printed circuit board (PCB) (e.g., for forming a conventional LED light bar) in the conventional structure, the glass substrate of the embodiment has a better heat transfer coefficient than printed circuit board.

The TFT-LCD manufacturing techniques may be applied for disposing the light-emitting elements (such as LEDs) on the glass substrate, thereby simplifying the product design or reducing the environmental pollution which is generated from the manufacturing processes (PCB manufacturing process causes high pollution to the environment). The display apparatus of the embodiment may increase opportunities to meet the electrical performance requirements of the product (such as the specifications of resistances, capacities, etc.), thereby producing a display apparatus with great reliability of electrical characteristics. Moreover, for a display manufacturer such as a LCD manufacturer, the transportation of some related parts may be saved, thereby simplifying the process flow of the related LCD product. Therefore, the structure or manufacturing process of the embodiment may be simple and suitable in the mass production.

The embodiments are described in details with reference to the accompanying drawings. It is noted that the details of the structures and procedures of the embodiments are provided for exemplification, and the described details of the embodiments are not intended to limit the present disclosure. Also, it is noted that not all embodiments of the disclosure are shown. Modifications and variations can be made without departing from the spirit of the disclosure to meet the requirements of the practical applications. Thus, there may be other embodiments of the present disclosure which are not specifically illustrated. Further, the accompany drawings are simplified for clear illustrations of the embodiment; sizes and proportions in the drawings are not directly proportional to actual products, and shall not be construed as limitations to the present disclosure. Thus, the specification and the drawings are to be regard as an illustrative sense rather than a restrictive sense. Also, the identical and/or similar elements of the embodiments are designated with the same and/or similar reference numerals.

Additionally, when a first material layer being formed at, on or above a second material layer have been described in the embodiments, it includes the condition of the first material layer contacting the second material layer. It also includes conditions of one or more material layers disposed between the first material layer and the second material layer, wherein the first material layer would be not directly contact the second material layer. Moreover, use of ordinal terms such as “first”, “second”, “third”, etc., in the specification and claims to modify an element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

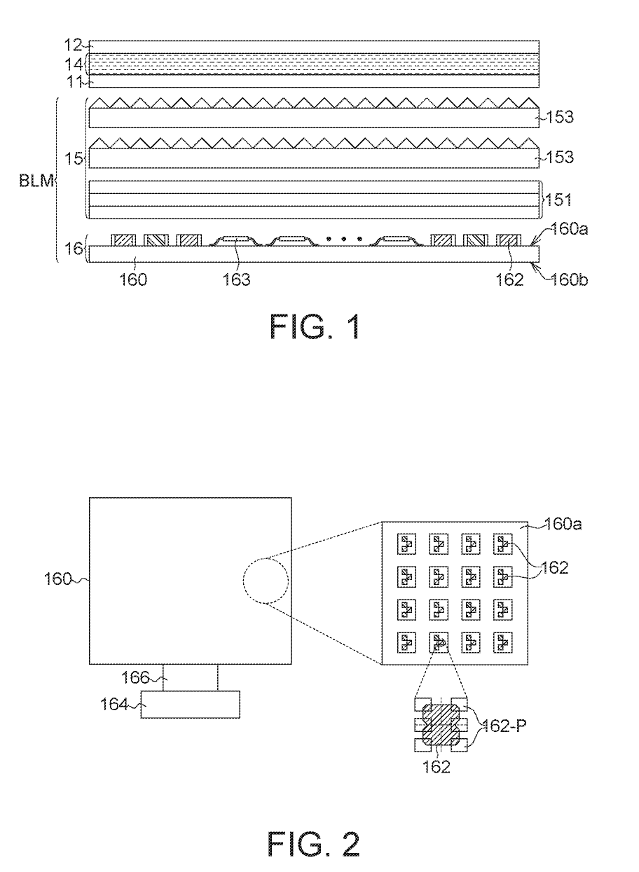

FIG. 1 is a cross-sectional view of a display apparatus according to one embodiment of the disclosure. A display apparatus includes a display panel 14, a first polarizer film 11 and a second polarizer film 12 respectively disposed below and above the display panel 14, a backlight module BLM disposed below the display panel 14 (for example, the backlight module BLM disposed below the first polarizer film 11) for providing light to the display panel 14. The backlight module BLM at least includes an optical film set 15 and a light source assembly 16, wherein the light source assembly 16 is disposed below the optical film set 15. In one embodiment, the optical film set 15 includes one or more optical films, such as including one or more diffuser sheets 151 and/or including one or more prism sheets 153 to adjust a light emitting angles (e.g. light concentration), as shown in FIG. 1. Although two prism sheets are exemplified as the optical films in FIG. 1, the disclosure has no limitation for the configurations, or number of the layers or types of the applicable prism structures. Additionally, the display panel 14 includes two substrates disposed oppositely, and a display medium layer (e.g., comprising liquid crystals, organic light emitting diodes (OLEDs), quantum dots LEDs (QLEDs or QD-LEDs), fluorescent materials, quantum dots, phosphorescent materials, florescent materials, light emitting diodes, micro light emitting diodes (micro-LEDs), mini light emitting diodes (mini-LEDs) or other display mediums, or other display medium, but the disclosure is not limited) between the two substrates. In some embodiments, the chip size of the light emitting diode is about 300 micrometers to 10 millimeters (mm), and the chip size of the mini LED is about 100 micrometers (μm) to 300 micrometers (μm). The size of a chip of a micro LED is about 1 micrometer (μm) to 100 micrometer (μm), but the disclosure is not limited thereto.

The display panel 14 does not include the polarizer film(s). In some embodiment, the display apparatus may be referred to a flexible display apparatus, a touch display apparatus, or a curved display apparatus; there is no particular limitation for the applicable types of the display apparatus in the disclosure.

According to the embodiment, the light source assembly 16 comprises a glass substrate 160, a plurality of light-emitting elements 162 (such as LEDs) and a plurality of driving elements 163. The driving elements 163 are electrically connected to the light-emitting elements 162, wherein at least several of the light-emitting elements 162 are disposed on the glass substrate 160. The examples below are provided for illustrating some of applicable dispositions of the light-emitting elements 162 and the driving elements 163.

FIG. 2 is a simple drawing illustrating the first type of a light source assembly of a display apparatus according to one embodiment of the disclosure. According to one embodiment, the light source assembly 16 comprises a glass substrate 160, a plurality of light-emitting elements 162 (such as LEDs, but the disclosure has no particular limitation thereto) disposed on the first surface 160a of the glass substrate 160, a printed circuit board (PCB) 164, a plurality of driving elements 163 disposed on (e.g., mounted on, but the disclosure has no particular limitation thereto) the printed circuit board 164, and a flexible substrate 166 respectively connected to the printed circuit board 164 and the glass substrate 160 for electrically connecting the driving elements 163 and the light-emitting elements 162 disposed on the glass substrate 160. Thus, in this example, the light-emitting elements 162 (such as LEDs) can be mounted on the glass substrate 160, and the driving elements 163 (such as components for driving the LEDs) can be mounted on the printed circuit board 164, wherein the glass substrate 160 and the printed circuit board 164 are electrically connected by the flexible substrate 166. In one embodiment, the flexible substrate 166 may be a flexible cable, a flexible printed circuit film (FPC), a flexible flat cable (FFC), or other applicable flexible components; the disclosure has no particular limitation thereto. In practical application, the printed circuit board 164 may be bended to a predetermined position through the flexible substrate 166. For example, the printed circuit board 164 may be bended to the position behind the glass substrate 160 for saving the space required for setting the related components.

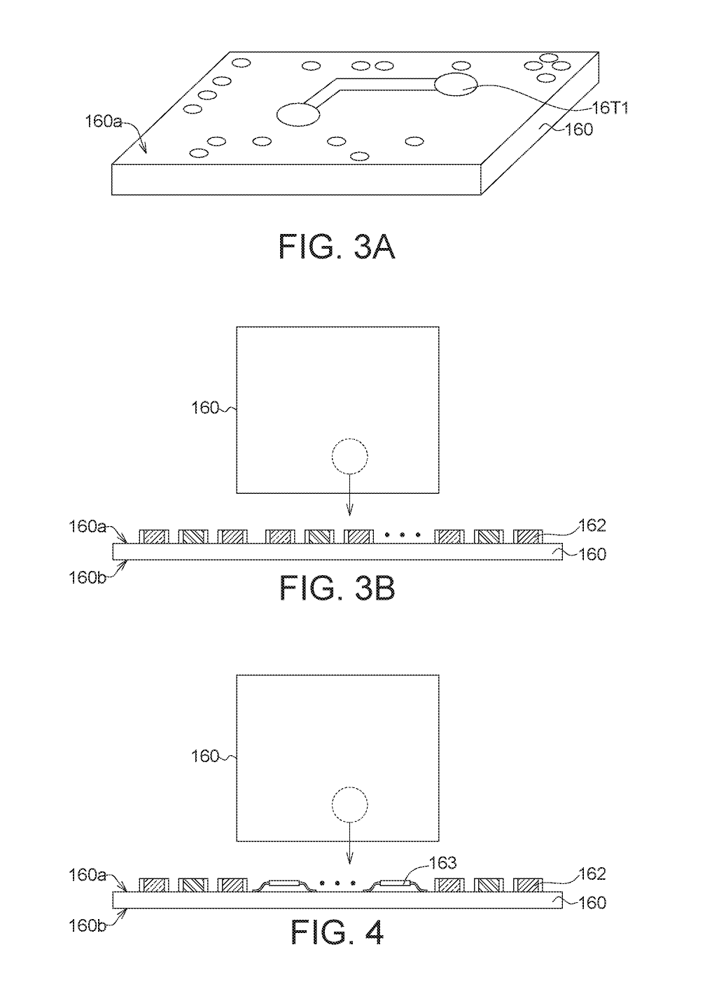

In this disclosure, the TFT-LCD manufacturing techniques may be applied for forming the conductive traces (e.g. related electrical circuits) on at least one of the upper surface and the lower surface. FIG. 3A is a simple drawing illustrating a glass substrate of the first type of a light source assembly according to a display apparatus of one embodiment of the disclosure. FIG. 3B illustrates the light-emitting elements disposed on the glass substrate of the first type of a light source assembly according to a display apparatus of one embodiment of the disclosure. The glass substrate 160 has a first surface 160a (such as the upper surface) and a second surface 160b (such as the lower surface) positioned oppositely to the first surface 160a. A first conductive trace layer 16T1 may be disposed on the first surface 160a of the glass substrate 160. Several light-emitting elements 162 may be disposed on the first surface 160a of the glass substrate 160 by an anisotropic conductive film (ACF) or solder pastes, but the disclosure has no particular limitation thereto. The light-emitting elements 162 may be electrically connected to the first conductive trace layer 16T1. The driving elements 163 may be disposed on a printed circuit board 164 (as shown in FIG. 2). In this example, the glass substrate 160 may further comprise through holes (i.e. the circles depicted in FIG. 3A) or other circuits not illustrated in the drawings. The disclosure has no particular limitation for the components and the types of circuits on the glass substrate.

In one embodiment, as shown in FIG. 2, three light-emitting elements 162 (such as a red light emitting diode, a blue light emitting diode or a green light emitting diode) may be disposed correspondingly to on pixel region, but the disclosure has no particular limitation thereto. Several metal pads 162-P may be correspondingly disposed below one of the light-emitting elements 162. The light-emitting element 162 may be mounted on the metal pads 162-P by an anisotropic conductive film (ACF) or solder pastes. Although FIG. 2 depicts six metal pads 162-P corresponding to one light-emitting element 162, the disclosure is not limited thereto. The number of the metal pads may be determined according to the designs of the practical application, and no particular limitation for the number of the metal pads. Less or more than six metal pads would be applicable as long as the electrical connection and disposition of the light-emitting element may be achieved.

Of course, that the disclosure is not limited to the configuration of FIG. 2 and FIG. 3B which illustrate the light-emitting elements 162 disposed on the glass substrate 160, and the driving elements 163 disposed on the printed circuit board 164. In other embodiments, the light-emitting elements 162 and the driving elements 163 may be disposed on the glass substrate 160. FIG. 4 illustrates the second type of a light source assembly according to a display apparatus of one embodiment of the disclosure. In the example of FIG. 4, the light-emitting elements 162 and the driving elements 163 are disposed on the first surface 160a of the glass substrate 160 by an anisotropic conductive film (ACF) or solder pastes, but the disclosure has no particular limitation thereto.

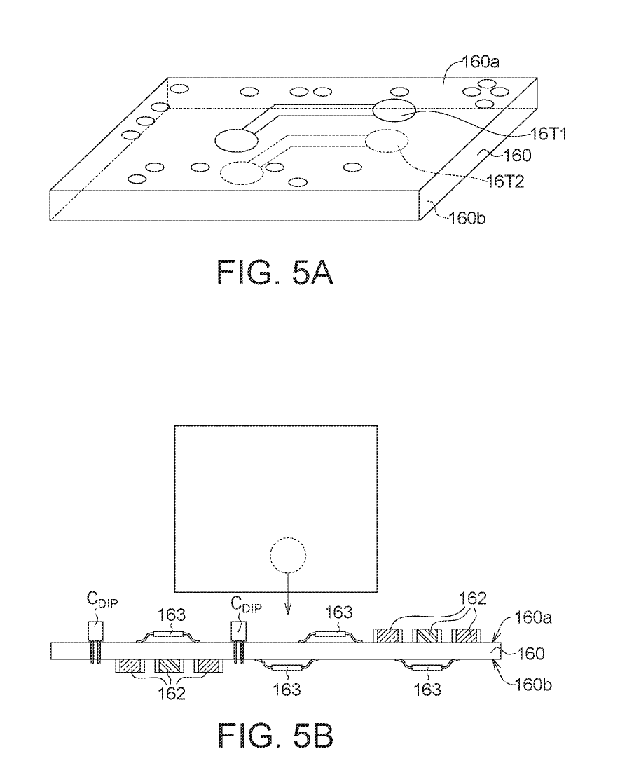

In other embodiments, related components may be disposed on both of the upper surfaces of the glass substrate 160 and lower surfaces of the glass substrate 160. For example, the light-emitting elements are disposed on both of the upper surface of the glass substrate 160 and the lower surface of the glass substrate 160; or the light-emitting elements are disposed on one of the upper surface and the lower surface, the driving elements are disposed on the other surface; or both of the upper surface and the lower surface of the glass substrate have the light-emitting elements and the driving elements disposed thereon. Those configurations are applicable types of the disclosure. FIG. 5A is a simple drawing illustrating a glass substrate of the third type of a light source assembly according to a display apparatus of one embodiment of the disclosure. FIG. 5B illustrates related components disposed on a glass substrate of the third type of a light source assembly according to a display apparatus of one embodiment of the disclosure. In the example of FIGS. 5A and 5B, a first conductive trace layer 16T1 and a second conductive trace layer 16T2 are respectively disposed on the first surface 160a and the second surface 160b of the glass substrate 160. The first conductive trace layer 16T1 is electrically connected to the second conductive trace layer 16T2 via the through holes (not depicted in the drawing) of the glass substrate. Several related components (such as the light-emitting elements 162 or/and the driving elements 163) may be respectively disposed on the first surface 160a of the glass substrate 160 and the second surface 160b of the glass substrate 160 for electrically connecting the first conductive trace layer 16T1 and the second conductive trace layer 16T2. In this example, it is no need to adopt an extra printed circuit board (PCB) for setting the driving elements 163. Other electronic components of the light source assembly may be also disposed on the glass substrate 160. The disclosure has no particular limitation for the way to set those electronic components. For example, those electronic components may be disposed on the conductive traces by surface mount technology (e.g. using an anisotropic conductive film (ACF) or solder pastes, but the disclosure has no particular limitation thereto), or those electronic components may be disposed on the conductive traces by dual in-line package (DIP) technology. As shown in FIG. 5B, the device C_{DIP} may be mounted on the glass substrate 160 by inserting the pins of the device C_{DIP} into the plating through holes of the glass substrate 160, wherein the solder paste may be formed in the plating through holes.

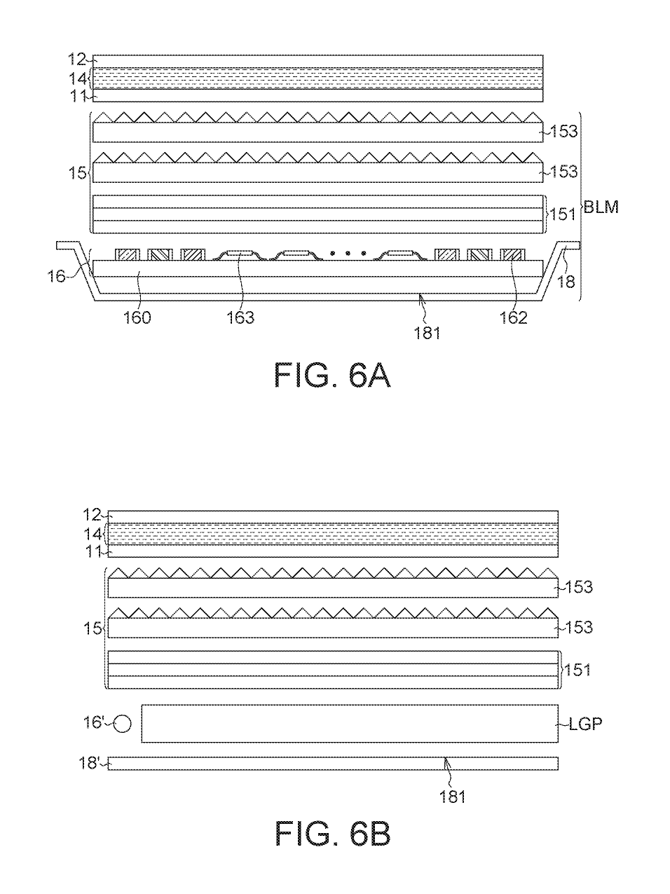

It is noted that FIG. 1 illustrates a direct-illumination type backlight (i.e. the light source assembly 16 may be disposed below the optical film set 15), but the disclosure has no limitation for the applicable types of backlight. A side-illumination type backlight may be applied in the embodiment of the disclosure. Please refer to FIG. 6A and FIG. 6B. FIG. 6A illustrates a display apparatus having a direct-illumination type backlight in one application of the disclosure. FIG. 6B illustrates a display apparatus having a side-illumination type backlight in another application of the disclosure. The identical and/or similar elements of FIG. 6A, FIG. 6B and FIG. 1 are designated with the same and/or similar reference numerals, and the details of the same elements have been described above and not redundantly repeated. In FIG. 6A and FIG. 6B, each of the backlight modules BLM further comprises a reflective plate 18/18′ disposed correspondingly to the light source assembly 16/16′. As shown in FIG. 6A, the light source assembly 16 of the display apparatus of this exemplified application is a direct-illumination type backlight, the light source assembly 16 is disposed above the reflective plate 18 or disposed within an accommodate space formed by the reflective plate 18. In other words, the glass substrate 160 is disposed between the reflective plate 18 and the display panel 14, a reflective surface 181 of the reflective plate 18 faces the light-emitting elements 162. As shown in FIG. 6B, the light source assembly 16′ of the display apparatus of this exemplified application is a side-illumination type backlight, wherein the backlight module 16′ further comprises a light guiding plate LGP disposed below the optical film set 15, and the backlight module 16′ may be disposed at one side of the light guiding plate LGP for providing light for the display panel. Also, configurations of the light source assembly 16′ may be the type of merely disposing the light-emitting elements 162 on the glass substrate 160 (as shown in FIG. 2), or the type of disposing the light-emitting elements 162 and the driving elements 163 on the glass substrate 160 (as shown in FIG. 4 or FIG. 5B), as described in the above examples. The disclosure has no limitation thereto. In the application type as shown in FIG. 6A and FIG. 6B, the glass substrate with the light-emitting elements 162 may be disposed between the reflective plate 18/18′ and the optical films 151/153; or the glass substrate with the light-emitting elements 162 may be disposed between the reflective plate 18/18′ and the display panel 14. It is noted that the disclosure has no particular limitation thereto.

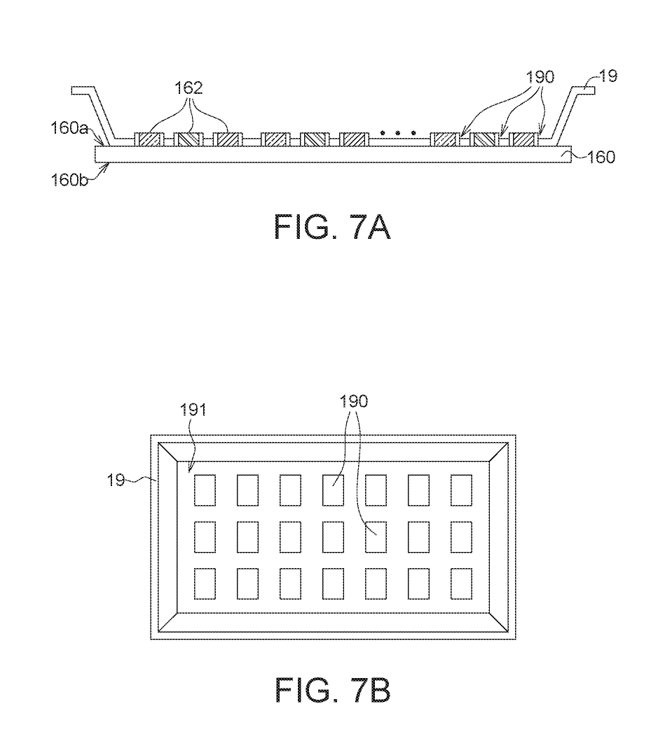

Moreover, the configuration of the reflective plate can be modified, and the reflective plates 18 and 18′ shown in FIG. 6A and FIG. 6B are provided for illustration, not for limitation. FIG. 7A illustrates another backlight module according to a display apparatus of one embodiment of the disclosure. FIG. 7B is a top view of the reflective plate in FIG. 7A (viewed from the reflective surface 191 of the reflective plate). As shown in FIGS. 7A and 7B, the backlight modules of the display apparatus of this exemplified application further comprises a reflective plate 19 disposed above the glass substrate 160. In other words, the reflective plate 19 may be disposed between the glass substrate 160 and the display panel 14, wherein the reflective plate 19 has the plurality of openings 190 positioned corresponding to the light-emitting elements 162. Arrangement of the light-emitting elements 162 may be one of the applicable types aforementioned above. Although the configuration of the light source assembly in FIG. 7A is identical to that in FIG. 3B, the disclosure is not limited thereto. Therefore, if a display apparatus comprising related components as shown in FIG. 1 is adopted for incorporating the reflective plate 19 of FIG. 7A as exemplification, the reflective plate 19 of the backlight module as shown in FIG. 7A may be positioned between the glass substrate 160 (at least the light-emitting elements are disposed on the glass substrate 160) and the optical film set 15 (including several optical sheets), or positioned between the glass substrate 160 and the display panel 14. In other words, the light-emitting elements can be regarded as disposed between the reflective plate 19 and the glass substrate 160. Please refer to FIG. 6A, FIG. 7A and FIG. 7B, the reflective plate 19 in FIG. 7A and FIG. 7B has several openings 190, while it is no need to form any opening in the reflective plate 18 (when the reflective plate 18 positioned below the light-emitting elements 162) of FIG. 6A. The reflective plate 18 (when the reflective plate 18 positioned under the light-emitting elements 162) of FIG. 6A may have a continuous surface without forming any opening. Since the glass substrate 160 is made of a transparent material, the reflective plate 18 of FIG. 6A may be disposed under the glass substrate 160 for directly reflecting the light passing through the glass substrate 160.

According to the embodiments, the light-emitting elements 162 (such as LEDs) and/or the driving elements 163 (such as the electronic elements for driving the LEDs) may be mounted on the glass substrate 160 for forming a glass LED light bar, wherein the TFT-LCD manufacturing techniques may be adopted for forming the related electrical circuits, and the elements may be disposed on the glass substrate 160 by the anisotropic conductive film (ACF) or solder pastes, but the disclosure has no particular limitation thereto. The embodiment has several advantages; for example, the TFT manufacturing process may form a thinner width of the conductive trace than the conventional PCB manufacturing process. Typically, a smallest width of a conductive trace formed by the conventional PCB manufacturing process is about 0.1 mm (=100 μm), while a smallest width of a conductive trace formed by the TFT manufacturing process may be reduced to 1 μm. In one embodiment, a width of the conductive trace disposed on a surface of the glass substrate may be equal to or greater than 7 μm, but less than or equal to 100 μm. The width of the conductive trace is determined according to the requirements of the practical application. When the embodiment is applied to a display apparatus in the application, it allows forming the conductive trace in a wide range of the thickness, depending on the actual needs of the applications. The thickness of the conductive trace on the glass substrate may be very small (e.g., 1-7 μm in thickness), and also can be very large such as greater than 50 μm (e.g., about 70 μm). Accordingly, the thickness of the conductive traces manufactured by the embodiment may be the same as the thickness of the conductive traces manufactured by the conventional PCB manufacturing process (e.g., 35 μm of the copper traces) or even more. The thickness of the conductive traces is determined according to the requirements of the practical application. When the embodiment is applied to form the conductive traces on the glass substrate, the widths and the thicknesses of the conductive traces may be determined according to the needs of the electrical current passing through the conductive traces or the heat dissipation, thereby complying with the requirements of the electrical properties of the product in the application. Generally, the thicker trace has better heat dissipation characteristic, and the wider trace has greater current throughput. Since the width and the thickness of the conductive trace of the embodiment may be variable in a wide range (i.e., varied from narrow to wide, or from thin to thick), the embodiment provides a wide range of process application. Additionally, the glass substrate of the embodiment (e.g. an alkali-free glass) has a heat transfer coefficient such as 1.4 W/mK (Wm⁻¹K⁻¹), which is higher than the heat transfer coefficient of the PCB (about 0.043 W/mK). When the related elements/components disposed on the glass substrate of the embodiment are operated and produce the heat (i.e. thermal energy), the heat would be directly or rapidly transferred by the glass substrate with excellent thermal conductivity for heat dissipation, thereby improving the performance and operational life of the product in the application.

According to the aforementioned descriptions, a backlight module of a display apparatus of the embodiment comprises a light source assembly having light-emitting elements disposed on a glass substrate, and a plurality of driving elements may be disposed on a printed circuit board (such as the types exemplified in FIG. 1-FIG. 3B). Therefore, it would be more flexible to utilize the space inside the display apparatus for setting the light source assembly. Alternatively, the light-emitting elements and the light-emitting elements may be disposed on the glass substrate (such as the types exemplified in FIG. 4-FIG. 5B), wherein the related elements/components may be disposed on a glass substrate having excellent thermal conductivity, or it is no need to adopt a PCB for disposing the elements. Additionally, in the exemplified types of disposing the light-emitting elements and the light-emitting elements on the glass substrate, the light-emitting elements and the light-emitting elements may be arranged on the same surface of different surfaces of the glass substrate. In other words, for one surface of the glass substrate, it may include the light-emitting elements or the light-emitting elements solely, or it may include the light-emitting elements and the light-emitting elements, depending on the designs of the practical applications; the disclosure has no particular limitation thereto. Moreover, the embodiment allows forming the conductive trace having the width or the thickness in the wide range, it would be more flexible to form the conductive traces with adequate widths and the thicknesses, thereby complying with the requirements of the electrical properties of the product in the application. Accordingly, the embodiment would not have adverse effects or limitations on the practical applications. Also, the glass substrate of the embodiment (e.g. an alkali-free glass) has a heat transfer coefficient such as 1.4 W/mK (Wm⁻¹K⁻¹), which is higher than the heat transfer coefficient of the PCB (about 0.043 W/mK). Therefore, the performance and operational life of the product in the application may be improved. The structure and manufacturing process of the embodiment may be suitable in the mass production.

In the aforementioned embodiments, the technique features described in one embodiment are not limited in the application of that embodiment. Structural details of the aforementioned embodiments, such as sizes of related components/layers or positions of related components/layers are provided for exemplification only, not for limitation. Other embodiments with different configurations, such as rearrange the known components, change on components of the related layers and the displaying elements to meet practical requirements, can be applicable. Of course, noted that the features of different embodiments may be combined and rearranged without departing from the spirit and scope of the present disclosure. It is known by people skilled in the art that the configurations and the procedure details of the related components/layers could be adjusted according to the requirements and/or manufacturing steps of the practical applications.

While the disclosure has been described by way of example and in terms of the exemplary embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display apparatus, comprising:
a display panel; and
a backlight module, disposed below the display panel, the backlight module at least comprising an optical film set and a light source assembly disposed below the optical film set, wherein the light source assembly comprises:
a glass substrate;
a plurality of light-emitting elements, disposed on the glass substrate; and
a plurality of driving elements, electrically connected to the plurality of light-emitting elements.

2. The display apparatus according to claim 1, wherein the backlight module further comprises:
a printed circuit board, the plurality of driving elements disposed on the printed circuit board; and
a flexible substrate, connected to the printed circuit board and the glass substrate for electrically connecting the plurality of driving elements and the plurality of light-emitting elements.

3. The display apparatus according to claim 2, wherein the printed circuit board is bended to a position behind the glass substrate through the flexible substrate.

4. The display apparatus according to claim 1, wherein a conductive trace is disposed on a surface of the glass substrate, and a width of the conductive trace is in a range of equal to or greater than 7 μm, and less than or equal to 100 μm.

5. The display apparatus according to claim 1, wherein a conductive trace is disposed on the glass substrate, and a thickness of the conductive trace is greater than 50 μm.

6. The display apparatus according to claim 1, wherein the backlight module further comprises a light guiding plate, and the glass substrate is disposed at one side of the light guiding plate.

7. The display apparatus according to claim 1, wherein the backlight module further comprises a reflective plate disposed correspondingly to the light source assembly.

8. The display apparatus according to claim 7, wherein the glass substrate is disposed between the reflective plate and the display panel, and a reflective surface of the reflective plate faces the plurality of light-emitting elements.

9. The display apparatus according to claim 7, wherein the plurality of light-emitting elements are disposed between the reflective plate and the glass substrate.

10. The display apparatus according to claim 7, wherein the reflective plate is disposed between the glass substrate and the display panel.

11. The display apparatus according to claim 10, wherein the reflective plate has a plurality of openings positioned corresponding to the plurality of light-emitting elements.

12. The display apparatus according to claim 1, wherein the glass substrate has a first surface and a second surface positioned oppositely, a first conductive trace layer is disposed on the first surface, and the plurality of light-emitting elements are electrically connected to the first conductive trace layer.

13. The display apparatus according to claim 12, wherein a second conductive trace layer is disposed on the second surface, the glass substrate comprises a plurality of through holes, and the first conductive trace layer is electrically connected to the second conductive trace layer via the plurality of through holes.

14. The display apparatus according to claim 13, wherein the plurality of driving elements are electrically connected to the second conductive trace layer.

15. The display apparatus according to claim 1, wherein the light-emitting elements are disposed on the glass substrate by an anisotropic conductive film or solder pastes.

16. The display apparatus according to claim 1, wherein the plurality of driving elements are disposed on the glass substrate.

17. The display apparatus according to claim 16, wherein the plurality of driving elements are disposed on the glass substrate by an anisotropic conductive film or solder pastes.

18. The display apparatus according to claim 1, wherein the glass substrate comprises a first surface and a second surface opposite to the first surface, and the plurality of light-emitting elements are disposed on the first surface and the second surface.

19. The display apparatus according to claim 1, wherein the plurality of light-emitting elements are light emitting diodes.

20. The display apparatus according to claim 1, wherein the glass substrate is an alkali-free glass.
